(19) United States
(12) Patent Application Publication
(10) Pub. No.: US 2018/0119887 A1
(43) Pub. Date: May 3, 2018

(54) VALVE AND PRESSURIZED FLUID TANK

(71) Applicant: L'Air Liquide, Société Anonyme pour l'Etude et l'Exploitation des Procédés Georges Claude, Paris (FR)

(72) Inventors: Christophe Roland REZEL, Antony (FR); Nouredine KISSI, Antony (FR)

(21) Appl. No.: 15/564,811

(22) PCT Filed: Apr. 5, 2016
(86) PCT No.: PCT/FR2016/050771

§ 371 Date: Oct. 6, 2017

(30) Foreign Application Priority Data
Apr. 7, 2015 (FR) 1552954

(51) Int. Cl. F17C 13/04

(52) U.S. Cl. CPC F17C 13/04; F17C 2205/0329; F17C 2205/0338; F17C 2250/0478; F17C 2205/0394; F17C 2221/011; F17C 2250/032; F17C 2205/0382

(57) ABSTRACT

A valve for a pressurized fluid tank including a body housing a withdrawal circuit including an upstream first end designed to communicate with a pressurized fluid storage volume and a downstream second end designed to be connected to a downstream member using a withdrawn fluid, the withdrawal circuit including a regulation member for regulating the flow rate and/or the pressure of the withdrawn fluid between the upstream and downstream ends.

### CROSS REFERENCE TO RELATED APPLICATIONS

This application is a 371 of International PCT Application PCT/FR2016/050771, filed Apr. 5, 2016, which claims priority to French Patent Application No. 1552954, filed Apr. 7, 2015, the entire contents of which are incorporated herein by reference.

### BACKGROUND

The present invention relates to a valve for pressurized fluid tank and a cylinder comprising such a valve.

### SUMMARY

The invention relates more particularly to a valve for pressurized fluid tank comprising a body having a withdrawal circuit comprising an upstream first end intended to communicate a pressurized fluid storage volume and downstream second end intended to be connected to a member using the withdrawn gas, the withdrawal circuit comprising a member for regulating the flow rate and/or the pressure of the withdrawn fluid between the upstream and downstream ends, the valve comprising a manual control member for the regulation member, the control member being mounted to be movable relative to the body of the valve and cooperating with the regulation member to control the flow rate and/or the pressure of fluid admitted to circulate from the upstream end to the downstream end according to the position of the control member in relation to the body, the valve comprising a device detecting the position of the control member that is electrically powered, the valve comprising an electrical power source linked to said detection device.

The invention relates in particular to an electrical or electronic system for detecting the position of a movable valve selector provided with a switch making it possible to allow or stop the electrical powering of at least a part of the detection device by the electrical power source according to the position the position of the control member.

The switch can be used to allow or stop the electrical powering of other electrical members of the valve or linked to the valve.

The document U.S. Pat. No. 3,839,662 describes a position detection device comprising several fixed discrete sensors cooperating with several movable discrete elements (see also WO201216420A or WO2014053371A).

These known devices do however present drawbacks including: a complex or costly structure, measurement inaccuracy for example between two referenced positions, excessive energy consumption, response time too slow, etc.

One aim of the present invention is to mitigate all or part of the drawbacks of the prior art stated above.

To this end, the valve according to the invention, otherwise conforming to the generic definition given of it by the above preamble, is essentially characterized in that the detection device comprises a single discrete mobile magnetic element secured to the control member and a first sensor and a second sensor fixedly mounted on the body of the valve, the first sensor being a magnetic sensor electrically powered by the power source, the second sensor being configured to form, with the control member, a switch stopping the first sensor from being electrically powered by the electrical power source when the control member is in at least a first determined position and allowing the first sensor to be electrically powered by the electrical power source when the control member is in at least a second determined position.

This structure makes it possible in particular to guarantee both a low electrical consumption, a reduced response time and significant detection accuracy.

Moreover, embodiments of the invention can comprise one or more of the following features:
the magnetic element comprises a permanent magnet generating a magnetic field, the first sensor being a magnetic sensor measuring the magnetic field to determine the position of the control member from a measured value of said magnetic field,
the first sensor is a magnetic sensor measuring at least one out of: the angle of the magnetic field, the intensity of the magnetic field, the orientation of the magnetic field,
the second sensor is a magnetic sensor,
the second sensor comprises or consists of a magnetically actuated electrical switch,
the valve comprises an electronic data acquisition, storage and processing member, in particular an integrated circuit and/or microprocessor, and in that the detection device is linked to said electronic member and in that the electronic member is configured to control the electrical powering or the stopping of the electrical powering of the first sensor by the electrical power source as a function of a signal delivered by the second sensor and/or of a switching state of the second sensor,
the first sensor is a magnetic sensor measuring the angle of the magnetic field of the magnetic element and converting the measured angle value into an electrical signal of determined intensity, for example an electrical voltage, said electrical signal being transmitted to the electronic data acquisition, storage and processing member and in that the control member (5) can be moved into a plurality of determined distinct second positions in which the values of the angle of the magnetic field of the magnetic element measured are distinct and are converted into electrical signals of respective distinct intensities,
the control member is mounted to move in rotation about an axis of rotation on the body of the valve,
the magnetic element comprises a bipolar magnet, that is to say comprising a north pole and a south pole, the axis passing through the two poles of the magnetic element not being parallel to the axis of rotation of the control member,
the control member can be moved between a first position called “closure position” in which the control member positions the regulation member in a configuration of closure of the first withdrawal circuit and a plurality of second positions called “opening positions” in which the control member positions the regulation member in respective configurations of opening of the first withdrawal circuit to allow fluid to circulate from the upstream end to the downstream end with a determined flow rate and/or pressure, when the control member is in its first closure position, the magnetic field of the magnetic element activating the second sensor to trigger the stopping of the electrical powering of the first sensor by the electrical power source, when the control member is at least one of the second opening positions, the magnetic field of the magnetic element not activating the second sensor and allowing the electrical powering of the first sensor by the electrical power source,
the valve comprises an electronic device indicating data relating to the fluid content in a cylinder connected to the valve, the electronic indication device comprising a data acquisition, storage and processing member and at least one data display linked to the data acquisition, storage and processing member, the position sensor being linked to the data acquisition, storage and processing member to transmit to the latter a signal representative of the fluid flow rate and/or pressure imposed by the regulation member, the data acquisition, storage and processing member being configured, in response to the reception of this imposed flow rate and/or pressure signal, to order the display on the display of information relating to the fluid flow rate and/or pressure imposed by the regulation member and/or the mode of use of the valve,
the first sensor is configured to perform measurements periodically with a controlled variable frequency, notably a high first frequency in a time interval following a detection of a switchover of the control member from the first position to a second position and a reduced second frequency lower than the first frequency after a determined time interval and/or when the pressure measured by a pressure sensor in the cylinder detects a pressure below a determined threshold, that is to say that the measurement from the first sensor can be paced differently as a function of the time and/or the situation: a rapid response time to the opening of the valve, then less often (even very much less often) when the measured pressure indicates an empty cylinder for example,
the device for detecting the position of the control member comprises a single detectable movable element consisting of the magnetic element and two detection elements consisting of the first and second sensors,
the first and second sensors are positioned adjacent and offset in a direction transversal to the axis of rotation of the control member and/or offset in a direction parallel to the axis of rotation of the control member and/or offset according to an angle of rotation in relation to the axis of rotation,
the axis passing through the two poles of the magnetic element is at right angles to the axis of rotation the control member,
the valve comprises a pressure sensor intended to measure the pressure in the storage volume of a fluid cylinder connected to the valve, the pressure sensor being linked to the data acquisition, storage and processing member to transmit to the latter a signal representative of the measured fluid pressure, the data acquisition, storage and processing member being configured, in response to the reception of this pressure signal, to calculate and display on the display remaining reserve or remaining fluid content information,
the data acquisition, storage and processing member is configured to calculate and display automatically an update of the remaining reserve or fluid content information on reception of a signal from the position sensor indicating a change of flow rate and/or the fluid pressure imposed by the regulation member via the control member.

The invention can relate also to any alternative device or method comprising any combination of the features above or below.

The invention relates also to a pressurized fluid cylinder comprising a valve according to any one of the features above or below.

### BRIEF DESCRIPTION OF THE DRAWINGS

Other particular features and advantages will become apparent on reading the following description, given with reference to the figures in which:

FIG. 1 represents a schematic and partial side view, illustrating a valve mounted on a pressurized gas cylinder according to a possible exemplary embodiment of the invention,

FIG. 2 illustrates, schematically and partially, the structure and the operation of a part of the valve of FIG. 1, in particular a selector position detection device,

FIG. 3 illustrates, schematically and partially, an example of measurement curve from a sensor of the detection device of FIG. 2 according to the position of the selector,

FIG. 4 represents a schematic and partial vertical cross-sectional view of a detail of a valve illustrating one position of a movable control member (selector) provided with a position detection device according to a first exemplary embodiment,

FIG. 5 represents a schematic and partial vertical cross-sectional view of a detail of a valve illustrating a different position of a movable control member (selector) provided with a position detection device according to a first exemplary embodiment,

FIG. 6 represents a vertical cross-sectional view similar to that of FIG. 4 illustrating a second exemplary embodiment,

FIG. 7 represents a schematic and partial side view, illustrating a possible example of magnet of the detection device according to the invention,

FIG. 8 illustrates, schematically and partially, the structure and the operation of a part of the valve of FIG. 1.

### DESCRIPTION OF PREFERRED EMBODIMENTS

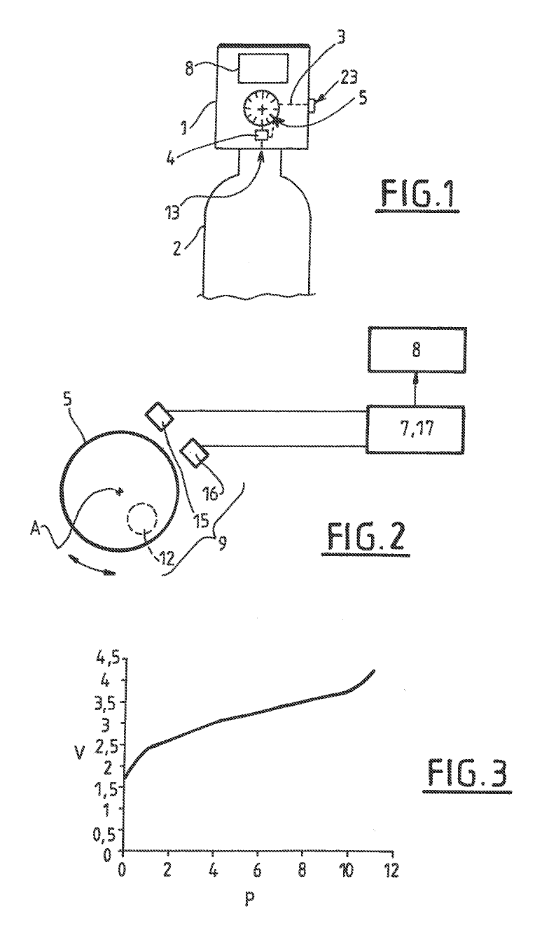

The valve illustrated in FIGS. 1 and 8 in particular conventionally comprises a body housing a withdrawal circuit 3 comprising an upstream first end 13 intended to communicate a pressurized fluid storage volume (interior of the cylinder 2) and a downstream second end 23 intended to be connected to a member using the withdrawn gas (for example oxygen for a patient, a ventilator, a mask or any other apparatus).

The withdrawal circuit 3 comprises a member 4 for regulating the flow rate and/or the pressure of the withdrawn fluid between upstream 13 and downstream 23 ends. This regulation member 4 can comprise a flow rate and/or pressure regulator comprising, for example, a valve, a system of gauged orifices or any other appropriate device.

The valve 1 comprises a manual control member 5 for the regulation member 4, that is to say a selector that can be actuated at least manually.

Conventionally, the control member 4 is mounted to be moveable relative to the body of the valve 1, for example in rotation, and cooperates with the regulation member 4 to control the flow rate and/or the pressure of fluid admitted to circulate from the upstream end 13 to the downstream end 23 according to the position of the control member 5 in relation to the body. In other words, the position of the selector 5 modifies (mechanically and/or electrically and/or pneumatically and/or hydraulically) the gas flow rate or pressure setting in the circuit imposed by the regulation member 4.

The valve 1 further comprises an electrical device 9 for detecting the position of the control member 5. To this end, the valve 1 comprises a power source 7 linked to said detection device 9 (and possibly to other electrical members). The power source 7 for example comprising an electric battery.

According to an advantageous feature, the detection device 9 comprises a single discrete mobile magnetic element 12 secured to the control member 5 and a first sensor 15 and a second sensor 16 fixedly mounted on the body of the valve 1.

The first sensor 15 is preferably a magnetic sensor electrically powered by the power source 7 or any other equivalent sensor. The second sensor 16 is, for its part, configured structurally and/or functionally to form, with the control member 5, a switch. This switch is configured to stop the electrical powering of the first sensor 15 by the electrical power source 7 when the control member 5 is in at least a first determined position and allow the electrical powering of the first sensor 15 by the electrical power source 7 when the control member 12 is in at least a second determined position. The second sensor 16 is preferably a magnetic sensor. For example, the second sensor 16 comprises or consists of a magnetically actuated electrical switch. For example, the first sensor 15 is a magnetic switch (reed switch), a flexible blade switch (ILS) or bimetallic strip or any other appropriate sensor. For example, this first sensor 15 is a sensor of the AC011520 type from the company CELDUC.

For example, the switch (via the second sensor 16) cuts the electrical power supply of the first sensor 15 when the control member 5 is in a position of closure of the valve circuit (zero flow rate downstream) and, on the contrary, allows the electrical powering when the control member 5 is in a position of opening of the circuit (withdrawal of gas and non-zero flow rate downstream).

This simple and inexpensive structure allows for a fast response time for the selector 5 position detection and also makes it possible to reduce and control the electrical consumption of the detection device and, more generally, of the valve.

To this end, the switch and/or the first sensor can control the powering or the activation of other electrical members of the valve according to the detected position of the control member 5.

Preferably, the magnetic element 12 borne by the control member 5 comprises or consists of a permanent magnet generating a magnetic field. The first sensor 15 is, for its part, a magnetic sensor measuring the magnetic field to determine the position of the control member 5 from a measured value of said magnetic field.

The first sensor 15 is, for example, a magnetic sensor measuring at least one out of the angle of the magnetic field, the intensity of the magnetic field, the orientation of the magnetic field.

In other words, the first sensor 15 detects the precise position of the control member 5 whereas the second sensor 16 constitutes a switch which controls the powering or not of the first sensor (and possibly of other electrical members). In other words, the electrical consumption of the device is reduced (first sensor put to sleep or switched off together with other members) in certain determined situations, in particular: valve closed, cylinder empty, etc.

The valve 1 preferably comprises an electronic data acquisition, storage and processing member 17, in particular an integrated circuit and/or a microprocessor. The detection device 9 is linked to said electronic member 17 or integrated therein. The electronic member 17 can be configured to control the electrical powering or the stopping of the electrical powering of the first sensor 15 by the electrical power source 7 as a function of a signal delivered by the second sensor 16 and/or of a switching state of the second sensor 16.

The first sensor 15 is preferably a magnetic sensor measuring the angle of the magnetic field of the magnetic element 12 and converting the measured angle value into a signal, for example electrical of determined intensity.

For example, this signal can comprise an electrical voltage. The electrical signal can be transmitted to the electronic data acquisition, storage and processing member 17.

Thus, the control member 5 can be movable into a plurality of determined distinct second positions in which the values of the angle of the magnetic field of the magnetic element 12 measured are distinct and are converted into electrical signals of respective distinct natures or intensities. This makes it possible to measure and determine one position out of others with a simple structure, few parts and reduced electrical consumption.

FIG. 3 illustrates, for example, a representative signal (Y axis representing, for example, a voltage value V in volts) as a function of positions (twelve positions P on the X axis).

The control member 5 is for example mounted to be movable in rotation about an axis A of rotation on the body of the valve. In other words, the control member is for example a rotary selector. Obviously, this structure can be used to detect a position of a selector that is movable in translation or movable according to other simple or complex movements.

For example, the magnetic element 12 comprises or consists of a bipolar magnet, that is to say comprising a north pole (N) and a south pole (S), see FIG. 7. Preferably, the axis passing through the two poles and at right angles to the two poles of the magnetic element 12 is not parallel to the axis of rotation of the control member 5.

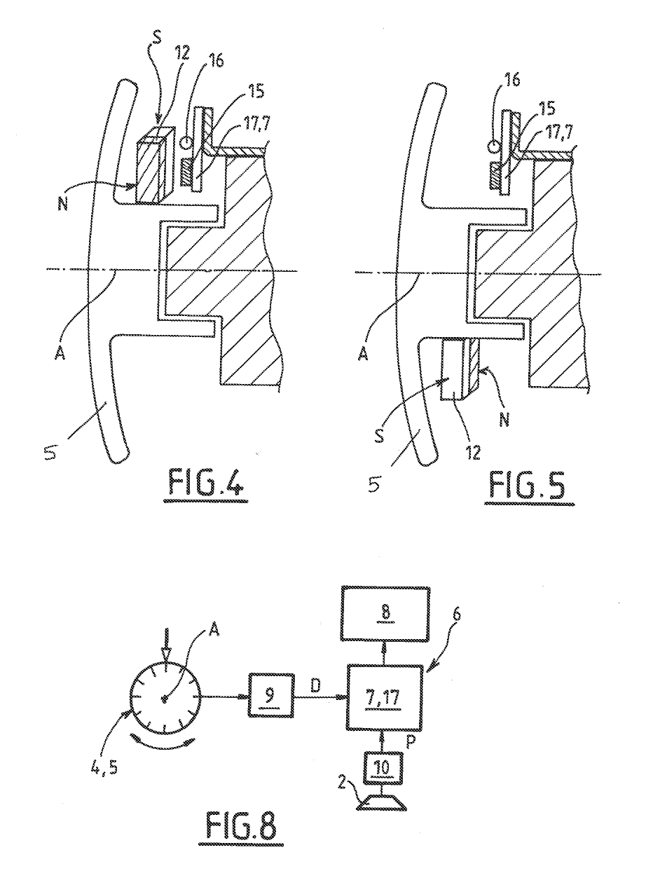

FIGS. 4 to 6 illustrate two nonlimiting examples of incorporation of such a magnet 12 in a rotary selector. The magnet 12 can be fixed to the selector 5 in a cavity away from the axis A of rotation. FIG. 4 illustrates the magnet 12 in position adjacent to (facing) the second sensor 16 and in a first position relative to the first sensor 15. The position of FIG. 4 can correspond for example to a position of closure of the valve (selector 5) in position of closure of the circuit. In the position of FIG. 5, the selector 5 has been turned about its axis A (for example 180 degrees), the magnet 12 is in a position relatively further away from the second sensor 16 and in a second position relative to the first sensor 15. In the embodiment of FIGS. 4 and 5 the magnet 12 and the two sensors 15, 16 are situated, for example, respectively in distinct parallel planes. For example, on the one hand the magnet 12 and on the other hand the two sensors 15, 16 are for example situated respectively in two planes at right angles to the axis A of rotation (for example vertical planes when the valve is in vertical position).

For example, the magnet 12 is displaced in a plane at right angles to the axis A of rotation and not containing the sensor or sensors 15, 16. The sensor or sensors 15, 16 and the magnet 12 can be situated at one and the same distance from the axis A of rotation (or a different distance).

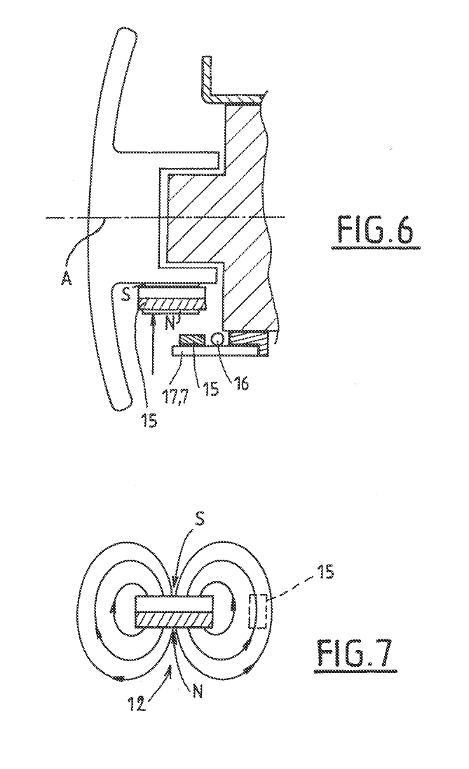

In the variant of FIG. 6, the magnet 12 can have a different orientation in relation to the axis A of rotation. Furthermore, the sensor or sensors 15, 16 can be placed around the magnet (concentrically in relation to the axis A of rotation). In other words, the magnet 12 is displaced in a plane at right angles to the axis A of rotation and able to contain the sensor or sensors 15, 16. The sensor or sensors 15, 16 and the magnet 12 can be situated at different distances from the axis A of rotation.

A multitude of relative positionings of the magnet 12 and of the sensors are of course possible.

For example, the control member 5 can be displaced between a first position called “closure position” in which the control member 5 positions the regulation member 4 in a configuration of closure of the first withdrawal circuit 3 and a plurality of second positions called “opening positions” in which the control member 5 positions the regulation member 4 in respective configurations of opening of the first withdrawal circuit 3 to allow fluid to circulate from the upstream end 13 to the downstream end 23 with respective determined flow rates (or respective pressures).

When the control member 5 is in its first position of closure, the magnetic field of the magnet element 12 activates the second sensor 16 to preferably trigger the stopping of the electrical powering of the first sensor 15 by the electrical power source 7. When the control member 5 is at least one of the second opening positions (for example one of the non-zero flow rates selected), the magnetic field of the magnetic element 12 does not active the second sensor 16 and allows the electrical powering of the first sensor 15 by the electrical power source 7.

As illustrated in FIG. 1, the valve 1 can comprise an electronic device 6 indicating data relating to the fluid content in a cylinder connected to the valve 1 such as a pressure gauge (see for example FR2868160A1 or FR2915798A1).

The electronic indication device 6 comprises, for example, a data acquisition, storage and processing member 17 and at least one data display 8 linked to the data acquisition, storage and processing member 17. The position sensor 9 can be linked to the data acquisition, storage and processing member 17 to transmit to the latter a signal representative of the fluid flow rate and/or pressure imposed by the regulation member 4. Furthermore, the data acquisition, storage and processing member 7 can be configured, in response to the reception of this imposed flow rate and/or pressure signal, to order the display on the display 8 of information relating to the fluid flow rate and/or pressure imposed by the regulation member 4 and/or the mode of use of the valve. Similarly, the data acquisition, storage and processing member 17 can be configured to calculate a remaining quantity of gas (remaining reserve in volume or in usage time) from this measurement and/or from a measurement of pressure in the cylinder).

The selector position sensor device and in particular the switch formed by the second sensor 16 can also selectively control the electrical powering of the display or adapt its display according to the detected position of the selector 5.

Similarly, depending on the detected position of the selector 5, all or part of the operation of the interface members (display 8, sensors, etc.) can be modified.

Similarly, when the pressure measured in the cylinder 2 and/or when the remaining reserve is below a threshold (cylinder empty), the measurement frequency of the sensor or sensors or of the display can be modified automatically. In particular, the sampling frequency of the first sensor 15 and/or of the second sensor 16 can be reduced when the pressure is low (cylinder empty or almost empty).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-15. (canceled)

16. A valve for a pressurized fluid tank comprising a body housing a withdrawal circuit comprising an upstream first end configured to communicate with a pressurized fluid storage volume and a downstream second end configured to be connected to a downstream member using a withdrawn fluid, the withdrawal circuit comprising a regulation member for regulating the flow rate and/or the pressure of the withdrawn fluid between the upstream and downstream ends,
the valve comprising a manual control member for the regulation member, the manual control member being mounted to be movable relative to the body of the valve and cooperating with the regulation member to control the flow rate and/or the pressure of fluid admitted to circulate from the upstream end to the downstream end according to the position of the manual control member in relation to the body,
the valve comprising a detection device for detecting the position of the control member that is electrically powered,
the valve comprising an electrical power source linked to the detection device, wherein the detection device comprises a single discrete mobile magnetic element secured to the control member and a first sensor and a second sensor fixedly mounted on the body of the valve, the first sensor being a magnetic sensor electrically powered by the electrical power source, the second sensor being configured to form, with the control member, a switch stopping the first sensor from being electrically powered by the electrical power source when the control member is in at least a first predetermined position and allowing the first sensor to be electrically powered by the electrical power source when the control member is in at least a second predetermined position.

17. The valve as claimed in claim 16, wherein the magnetic element comprises a permanent magnet generating a magnetic field and in that the first sensor is a magnetic sensor measuring the magnetic field to determine the position of the control member from a measured value of the magnetic field.

18. The valve as claimed in 16, wherein the first sensor is a magnetic sensor measuring at least one characteristic selected from the group consisting of: the angle of the magnetic field, the intensity of the magnetic field, and the orientation of the magnetic field.

19. The valve as claimed in claim 16, wherein the second sensor is a magnetic sensor.

20. The valve as claimed in claim 16, wherein the second sensor comprises a magnetically actuated electrical switch.

21. The valve as claimed in claim 16, further comprising an electronic data acquisition, storage and processing member, and wherein the detection device is linked to the electronic member, and wherein the electronic member is configured to control the electrical powering or the stopping of the electrical powering of the first sensor by the electrical power source as a function of a signal delivered by the second sensor and/or of a switching state of the second sensor.

22. The valve as claimed in claim 21, wherein the first sensor is a magnetic sensor measuring the angle of the magnetic field of the magnetic element and converting the measured angle value into an electrical signal of determined intensity, the electrical signal being transmitted to the electronic data acquisition, storage and processing member, and wherein the control member can be moved into a plurality of determined distinct second positions in which the values of the angle of the magnetic field of the magnetic element measured are distinct and are converted into electrical signals of respective distinct intensities.

23. The valve as claimed in claim 21, further comprising an electronic device indicating data relating to the fluid content in a cylinder connected to the valve, the electronic indication device comprising the data acquisition, storage and processing member and at least one data display linked to the data acquisition, storage and processing member, and wherein the position sensor is linked to the data acquisition, storage and processing member to transmit to the latter a signal representative of the fluid flow rate and/or pressure imposed by the regulation member, the data acquisition, storage and processing member being configured, in response to the reception of this imposed flow rate and/or pressure signal, to order the display on the display of information relating to the fluid flow rate and/or pressure imposed by the regulation member and/or to the mode of use of the valve.

24. The valve as claimed in claim 16, wherein the control member is mounted to move in rotation about an axis (A) of rotation on the body of the valve.

25. The valve as claimed in claim 24, wherein the magnetic element comprises a bipolar magnet, and in that the axis passing through the two poles of the magnetic element is not parallel to the axis of rotation of the control member.

26. The valve as claimed in claim 16, wherein the movable magnetic element is arranged offset on the control member in relation to the axis of rotation so as to be placed adjacent to the first sensor and/or to the second sensor when the control member is in an extreme position corresponding to a minimum flow rate or pressure.

27. The valve as claimed in claim 16, wherein the control member can be moved between a first position called “closure position” in which the control member positions the regulation member in a configuration of closure of the first withdrawal circuit and a plurality of second positions called “opening positions” in which the control member positions the regulation member in respective configurations of opening of the first withdrawal circuit to allow fluid to circulate from the upstream end to the downstream end with a determined flow rate and/or pressure and in that, when the control member is in the first closure position, the magnetic field of the magnetic element activates the second sensor to trigger the stopping of the electrical powering of the first sensor by the electrical power source, and in that, when the control member is at least one of the second opening positions, the magnetic field of the magnetic element does not activate the second sensor and allows the electrical powering of the first sensor by the electrical power source.

28. The valve as claimed in claim 16, wherein the first sensor is configured to perform measurements periodically with a controlled variable frequency in a time interval following a detection of a switchover of the control member from the first position to a second position and a reduced second frequency lower than the first frequency after a determined time interval and/or when the pressure measured by a pressure sensor in the cylinder detects a pressure below a determined threshold.

29. The valve as claimed in any claim 16, wherein the manual control member can be moved into a plurality of distinct positions corresponding to respective distinct flow rate and/or pressure settings imposed by the regulation member in the circuit.

30. A pressurized fluid cylinder, comprising a valve as claimed in claim 16.
